(19) United States
(12) Patent Application Publication
(10) Pub. No.: US 2026/0322028 A1
(43) Pub. Date: Oct. 15, 2026

(54) TERMINAL SEAL FOR A POWER TERMINAL

(71) Applicant: TE Connectivity Solutions GmbH, Schaffhausen (CH)

(72) Inventor: Galen M. Martin, Middletown, PA (US)

(21) Appl. No.: 19/179,766

(22) Filed: Apr. 15, 2025

(51) Int. Cl. H01R 13/52

(52) U.S. Cl. CPC H01R 13/521

(57) ABSTRACT

A power terminal includes a terminal body extending between a mating end and a terminating end. The mating end is configured to be mated with a mating power terminal. The terminating end includes a crimp barrel configured to be crimped to a power cable. The power terminal includes a terminal seal coupled to the terminal body between the mating end and the terminating end. The terminal seal includes a seal body that has a slot. The slot receives the crimp barrel as the terminal seal is loaded over the crimp barrel onto the terminal body. The terminal seal is sealingly coupled to the terminal body forward of the crimp barrel.

### BACKGROUND OF THE INVENTION

The subject matter herein relates generally to power terminals.

Electric vehicles (EVs) have become increasingly popular as a sustainable alternative to traditional internal combustion engine vehicles. One critical component of an electric vehicle is the charging inlet assembly, which provides the interface between the vehicle and an external power source for battery recharging. The charging inlet assembly typically includes one or more power terminals housed within an inlet housing, which ensures secure electrical connections and protection from environmental factors.

To maintain optimal performance and reliability, it is essential to seal the power terminals within the charging inlet housing effectively. The seal prevents the ingress of moisture, dust, and other contaminants that could compromise the electrical connection, leading to potential short circuits, corrosion, or reduced charging efficiency. One common approach to sealing the power terminals is to employ molded seals that are directly formed around the terminals during the manufacturing process.

However, molded seals present several challenges and limitations. First, the molding process itself is complex and prone to variations, which can result in inconsistent sealing performance and dimensional inaccuracies. Additionally, molded seals are typically made from elastomeric materials that must adhere securely to the power terminals while maintaining flexibility and resistance to thermal cycling and environmental exposure. Achieving a reliable bond between the molded seal and the terminal material can be problematic, especially when the terminals are made of conductive metals that exhibit low adhesion properties.

Furthermore, the thermal expansion mismatch between the power terminals and the molded seal can lead to stress accumulation and eventual seal degradation. As electric vehicles often experience significant temperature fluctuations during operation and charging, the molded seal may become compromised over time, allowing moisture ingress and reducing the long-term durability of the charging inlet assembly.

Moreover, molded seals increase manufacturing complexity and cost, as specialized tooling and precise control of molding parameters are required. Replacing or servicing molded seals is also challenging, as they are typically not designed for easy disassembly or replacement, leading to potential maintenance difficulties.

There is, therefore, a need for an improved sealing solution for the power terminals of a charging inlet assembly that overcomes the limitations of molded seals while providing enhanced durability, reliability, and ease of manufacturing.

### BRIEF DESCRIPTION OF THE INVENTION

In one embodiment, a power terminal is provided and includes a terminal body extending between a mating end and a terminating end. The mating end is configured to be mated with a mating power terminal. The terminating end includes a crimp barrel configured to be crimped to a power cable. The power terminal includes a terminal seal coupled to the terminal body between the mating end and the terminating end. The terminal seal includes a seal body that has a slot. The slot receives the crimp barrel as the terminal seal is loaded over the crimp barrel onto the terminal body. The terminal seal is sealingly coupled to the terminal body forward of the crimp barrel.

In another embodiment, a power terminal is provided and includes a terminal body extending between a mating end and a terminating end. The mating end is configured to be mated with a mating power terminal. The terminating end includes a crimp barrel configured to be crimped to a power cable. The crimp barrel has a formed shape prior to crimping to the power cable and a crimped shape, different from the formed shape, after crimping to the power cable. The power terminal includes a terminal seal coupled to the terminal body between the mating end and the terminating end. The terminal seal includes a seal body that has a slot. The slot has a shape corresponding to the formed shape of the crimp barrel such that the slot is configured to receive the crimp barrel as the terminal seal is loaded over the crimp barrel onto the terminal body. The terminal seal is sealingly coupled to the terminal body forward of the crimp barrel.

In a further embodiment, a charging inlet assembly is provided and includes a charging inlet housing configured to be mounted to a vehicle. The charging inlet housing includes a charging receptacle configured to receive a charging plug. The charging inlet housing includes terminal channels open to the charging receptacle. The charging inlet assembly includes power terminals received in the terminal channels. Each power terminal includes a terminal body and a terminal seal coupled to the terminal body. The terminal body extends between a mating end and a terminating end. The mating end is located in the charging receptacle and configured to be mated with a mating power terminal of the charging plug. The terminating end includes a crimp barrel configured to be crimped to a power cable. The terminal seal includes a seal body that has a slot. The slot receives the crimp barrel as the terminal seal is loaded over the crimp barrel onto the terminal body. The terminal seal is sealingly coupled to the terminal body forward of the crimp barrel.

### BRIEF DESCRIPTION OF THE DRAWINGS

FIG. 1 is a front perspective view of a charging inlet assembly holding one or more power terminal assemblies in accordance with an exemplary embodiment and shows a charging plug assembly.

FIG. 2 is a perspective view of the power terminal in accordance with an exemplary embodiment.

FIG. 3 is a sectional view of the power terminal in accordance with an exemplary embodiment.

FIG. 4 is an exploded view of the power terminal assembly in accordance with an exemplary embodiment.

FIG. 5 is an enlarged, exploded view of a portion of the power terminal assembly shown in FIG. 4 in accordance with an exemplary embodiment.

FIG. 6 is a rear perspective view of the power terminal assembly in accordance with an exemplary embodiment showing the terminal seal coupled to the transition portion of the terminal body.

FIG. 7 is an end view of the power terminal assembly in accordance with an exemplary embodiment showing the terminal seal coupled to the terminal body.

FIG. 8 is a rear perspective view of the power terminal assembly in accordance with an exemplary embodiment showing the terminal seal coupled to the transition portion of the terminal body.

FIG. 9 is an end view of the power terminal assembly in accordance with an exemplary embodiment showing the terminal seal coupled to the terminal body.

### DETAILED DESCRIPTION OF THE INVENTION

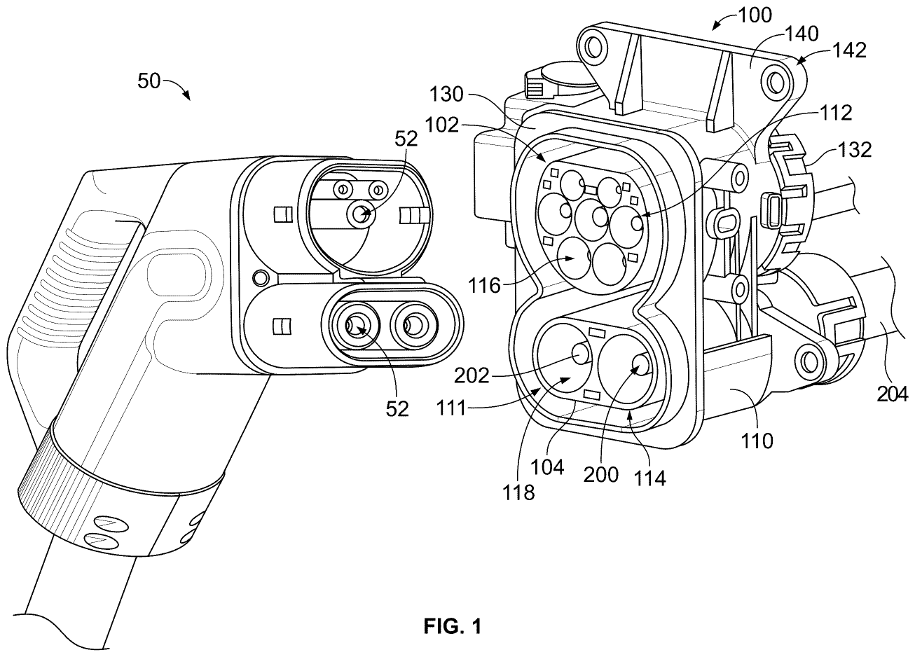

FIG. 1 is a front perspective view of a charging inlet assembly 100 holding one or more power terminal assemblies 200 in accordance with an exemplary embodiment. Each power terminal assembly 200 includes a power terminal 202 and a power cable 204 terminated to and extending from the power terminal 202. The charging inlet assembly 100 is used as a charging inlet for a vehicle, such as an electric vehicle (EV) or hybrid electric vehicle (HEV). The charging inlet assembly 100 is configured to be mated with a charging plug 50 such that charging plug power terminals 52 of the charging plug 50 are mated with the power terminals 202 of the charging inlet assembly 100. The power terminals 202 may be pin terminals and the power terminals 52 may be socket terminals, or vice versa. Other types of power terminals may be provided in alternative embodiments. The power terminals 202, 52 may be used in other types of power connectors in alternative embodiments other than the charging inlet assembly 100 and the charging plug 50.

In an exemplary embodiment, the charging inlet assembly 100 is configured for mating with various types of charging plugs, such as a DC fast charging connector (for example, the SAE combo CCS charging connector) and/or AC charging connectors (for example, the SAE J1772 charging connector). The charging inlet assembly 100 may be charging connectors associated with North American Charging System (NACS), such as SAE J3400 charging connectors. The charging inlet assembly 100 may include an AC charging module 102 and/or a DC charging module 104 in accordance with an exemplary embodiment.

The charging inlet assembly 100 includes a housing 110 configured to be mounted in the vehicle. The housing 110 holds the AC charging module 102 and the DC charging module 104 for mating with the charging connector. In various embodiments, components of the AC charging module 102 and/or the DC charging module 104 are removable from the housing 110, such as to the rear of the housing 110.

In an exemplary embodiment, the housing 110 includes a charging receptacle 111 configured to receive the charging plug 50. In an exemplary embodiment, the charging receptacle 111 includes an AC section 112 that receives the AC charging module 102 and a DC section 114 that receives the DC charging module 104.

The AC section 112 is configured for mating with an AC charging connector or an AC section of the charging connector. The housing 110 includes AC terminal channels 116 at the AC section 112 holding AC terminals of the power terminals 202. The AC terminals may include AC charging terminals, a ground terminal, a proximity terminal, a pilot terminal or other types of terminals. In an exemplary embodiment, the AC section 112 of the charging inlet assembly 100 defines a low-voltage connector configured to be coupled to the low-voltage portion of the charging connectors. The low-voltage connector is configured to be coupled to other components in the system, such as a battery distribution unit, to control charging of the vehicle. The low-voltage connector may transmit/receive signals relating to charging, such as status of connection, status of charge, voltage of charge, and the like.

The DC section 114 is configured for mating with a DC charging connector or a DC section of the charging connector. The housing 110 includes DC terminal channels 118 at the DC section 114 holding DC terminals of the power terminals 202. The DC terminals may include DC charging terminals and/or a ground terminal, a proximity terminal, a pilot terminal or other types of terminals. In an exemplary embodiment, the DC section 114 of the charging inlet assembly 100 defines a high-voltage connector configured to be coupled to the high-voltage portion of the charging connectors. The high-voltage connector is configured to be coupled to other components in the system, such as the battery system of the vehicle. For example, the power cables 204 may extend from the charging inlet assembly 100 to the battery system of the vehicle.

The inlet housing 110 includes a front 130 and a rear 132. The front 130 of the housing 110 faces outward and is presented to the operator to connect the charging connector. The rear 132 faces the interior of the vehicle. In an exemplary embodiment, the housing 110 includes a mounting flange 140 having mounting tabs 142 used for mounting the housing 110 to the vehicle. For example, the mounting tabs 142 may receive fasteners (not shown) to secure the charging inlet assembly 100 to the vehicle. Other types of mounting features may be used to secure the charging inlet assembly 100 to t he vehicle. The housing 110 and/or the mounting flange may include a seal to seal the charging inlet assembly 100 to the vehicle. In various embodiments, the charging inlet assembly 100 may include a terminal cover (not shown) at the front of the housing 110 to cover portions of the housing 110.

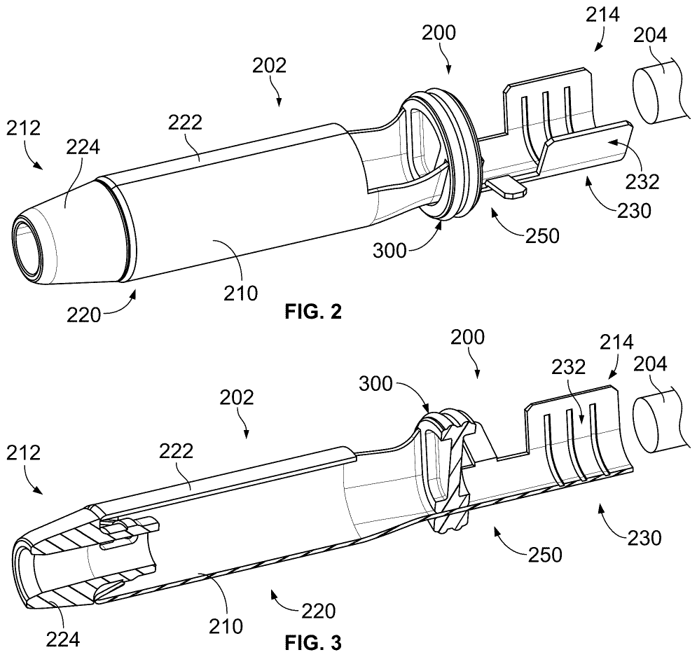

FIG. 2 is a perspective view of the power terminal 202 in accordance with an exemplary embodiment. FIG. 3 is a sectional view of the power terminal 202 in accordance with an exemplary embodiment. The power terminal 202 may be used with the charging inlet assembly 100, or another type of power connector including the charging plug 50, a receptacle connector, a socket connector, a header connector, or another type of connector.

The power terminal assembly 200 includes the power terminal 202 and a terminal seal 300 coupled to the power terminal 202. The power terminal 202 includes a terminal body 210. The terminal seal 300 is sealed to the terminal body 210. In an exemplary embodiment, the terminal body 210 is a stamped and formed terminal body stamped and formed from a piece of sheet metal into a predetermined shape. The terminal body 210 extends between a front 212 and a rear 214. The front 212 is configured to be mated with a mating power terminal, such as the power terminal 52. The power cable 204 is configured to extend from the rear 214. The terminal body 210 may be manufactured from copper, aluminum, stainless steel or other metal material. The terminal seal 300 is pre-formed and coupled to the terminal body 210. For example, the terminal seal 300 may be plugged or loaded onto the rear end of the terminal body 210. The terminal seal 300 is directly sealed to the terminal body 210 and is configured to be sealed to the housing 110, such as in the terminal channel of the housing 110.

The terminal body 210 extends between a mating end 220 at the front 212 and a terminating end 230 at the rear 214. The terminal body 210 includes a transition portion 250 between the mating end 220 and the terminating end 230. The shape of the terminal body 210 through the transition portion 250 transitions between the mating end 220 and the terminating end 230. The terminal seal 300 is configured to be coupled to the transition portion 250. The mating end 220 is configured to be mated with the mating power terminal 52. In the illustrated embodiment, the mating end 220 includes a pin 222 configured to be plugged into the socket of the power terminal 52. In an exemplary embodiment, the power terminal 202 includes a touch-proof cap 224 at the front 212. The touch proof cap 224 is manufactured from a dielectric material, such as a plastic material. The terminating end 230 is configured to be terminated to the power cable 204. In an exemplary embodiment, the terminating end 230 includes a crimp barrel 232 configured to be crimped to the power cable 204.

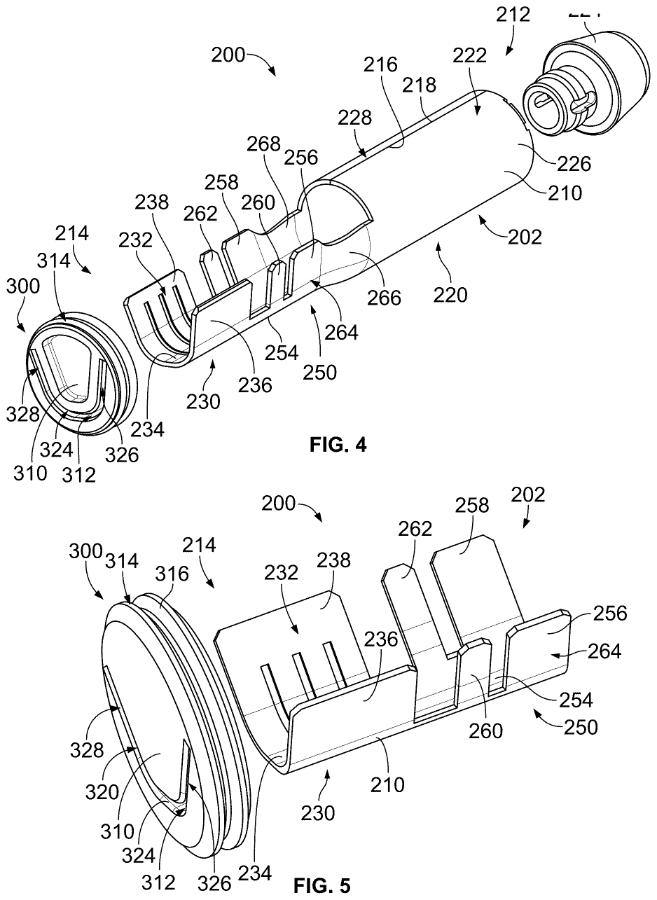

FIG. 4 is an exploded view of the power terminal assembly 200 in accordance with an exemplary embodiment. FIG. 5 is an enlarged, exploded view of a portion of the power terminal assembly 200 shown in FIG. 4. The power terminal assembly 200 includes the power cable 204, the power terminal 202 configured to be coupled to the power cable 204, and the terminal seal 300 configured to be sealed to the power terminal 202.

In an exemplary embodiment, the terminal body 210 is a stamped and formed terminal body. Edges 216, 218 of the stamped sheet or formed or bent into a predetermined shape. For example, the edges 216, 218 may be rolled into a cylinder 226 around a central bore at the mating end 220. The cylinder 226 may define at least a portion of the pin 222 or may define a socket. The touch-proof cap 224 is configured to be received in the cylinder 226 at the front 212 of the terminal body 210. The edges 216, 218 may meet at a seam 228 along the cylinder 226. The edges 216, 218 may be separated or spaced apart along the transition portion 250 and/or the terminating end 230. For example, the terminal body 210 may extend only partially around the central bore of the power terminal along the transition portion 250 and/or the terminating end 230, such as approximately half way around the central bore. The terminal body 210 may be U-shaped along the transition portion 250 and/or the terminating end 230. The terminal body 210 may have other shapes along the transition portion 250 and/or the terminating end 230. In various embodiments, a radius of curvature may be different along the mating portion 220 and/or along the transition portion 250 and/or along the terminating end 230. For example, the terminal body 210 may have different profiles along the mating portion 220 and/or along the transition portion 250 and/or along the terminating end 230.

The terminating end 230 is provided at the rear 214. The terminating end 230 is configured to be terminated to the power cable 204. In an exemplary embodiment, the terminating end 230 includes the crimp barrel 232 configured to be crimped to the end of the power cable 204. In an exemplary embodiment, the crimp barrel 232 includes a crimp base 234 between a first crimp arm 236 and a second crimp arm 238. The crimp base 234 may be curved to receive the end of the power cable 204. For example, the crimp base 234 may have a curvature that matches the curvature of the power cable 204. The crimp base 234 may be curved at the transitions to the first and second crimp arms 236, 238. In an exemplary embodiment, the first and second crimp arms 236, 238 extend upward from the crimp base 234 at angles away from each other. The first and second crimp arms 236, 238 may be flat or planar extending at the angles away from each other in the pre-crimp state. In alternative embodiments, the first and second crimp arms 236, 238 may be curved. The crimp barrel 232 is a crimp barrel profile in the pre-crimped state. For example, the crimp barrel profile may be generally U-shaped defined by the crimp base 234 and the first and second crimp arms 236, 238.

The first and second crimp arms 236, 238 are configured to be folded or bent arounds the end of the power cable 204 during the crimping process to mechanically and electrically connect the terminating end 230 to the power cable 204. For example, a hand crimp tool or a powered crimp applicator may bend or fold the first and second crimp arms 236, 238 around the power cable 204. In an exemplary embodiment, the terminal seal 300 is positioned on the terminal body 210 prior to crimping. For example, the terminal seal 300 may be rear loaded onto the end of the terminal body 210 and positioned forward of the crimp barrel 232, such as at the transition portion 250.

The transition portion 250 is located forward of the terminating end 230, such as between the crimp barrel 232 and the pin 222. The terminal body 210 may transition or change shape between the crimp barrel 232 and the pin 222 for example, the terminal body 210 may transition from a generally U-shaped crimp barrel 232 to a generally cylindrical shape pin 222. The transition portion 250 may include curved portions, flat portions, flared portions, or other transition portions.

In an exemplary embodiment, the transition portion 250 includes a transition base 254 between a first transition arm 256 and a second transition arm 258. The transition base 254 may be curved, such as having a curvature similar to the curvature of the crimp base 234. The transition base 254 may be curved at the transitions to the first and second transition arms 256, 258. In an exemplary embodiment, the first and second transition arms 256, 258 extend upward from the transition base 254 at angles away from each other. The first and second transition arms 256, 258 may be flat or planar extending at the angles away from each other. In alternative embodiments, the first and second transition arms 256, 258 may be curved.

In an exemplary embodiment, the first and second transition arms 256, 258 may have shapes (for example, curved or flat) and extend at angles that match the shapes and angles of the first and second crimp arms 236, 238. For example, in an exemplary embodiment, the transition portion 250 has a transition portion profile that matches the crimp barrel profile. For example, the transition portion profile may be generally U-shaped defined by the transition base 254 and the first and second transition arms 256, 258. The transition portion profile matches the crimp barrel profile to allow the terminal seal 300 to be loaded over the crimp barrel 232 onto the transition portion 250. Having the matching profiles allows the terminal seal 300 to be slid forward onto the rear 214 of the terminal body 210 over the crimp barrel 232 into position on the transition portion 250.

In an exemplary embodiment, the terminal body 210 includes retention wings 260, 262. In the illustrated embodiment, the retention wings 260, 262 are located along the transition portion 250. For example, the retention wings 260, 262 may be located between the crimp barrel 232 and a seal seat 264 of the transition portion 250 configured to receive the terminal seal 300. In an exemplary embodiment, the retention wings 260, 262 having a profile that matches the transition portion profile. For example, the retention wings 260, 262 have shapes in extended angles that match the shapes and angles of the first and second transition arms 256, 258 and/or the first and second crimp arms 236, 238. The matching profile allows the terminal seal 300 to slide forward from the crimp barrel 232 to the seal seat 264 over the retention wings 260, 262.

The retention wings 260, 262 are configured to be bent, such as outward, after the terminal seal 300 is loaded onto the seal seat 264. The retention wings 260, 262 are used to retain the terminal seal 300 at the seal seat 264. For example, the retention wings 260, 262 prevent the terminal seal 300 from moving rearwardly from the seal seat 264. In an exemplary embodiment, the terminal body 210 includes flared portions 266, 268 forward of the seal seat 264. The flared portions 266, 268 are flared outward relative to the first and second transition arms 256, 258. The flared portions 266, 268 are used to retain the terminal seal 300 at the seal seat 264. For example, the flared portions 266, 268 prevent the terminal seal 300 from moving forwardly from the seal seat 264.

The terminal seal 300 includes a seal body 310 having a slot 320. In the illustrated embodiment, the seal body 310 has a circular cross-section. The seal body 310 may have other shapes in alternative embodiments the shape of the seal body 310 may correspond to the shape of the terminal channel that receives the power terminal 202. The seal body 310 is manufactured from a material having effective sealing properties, such as rubber, silicone, ethylene propylene, PTFE, fluorosilicone, nitrile, and the like. The seal body 310 includes an inner seal surface 312 configured to be sealingly coupled to the terminal body 210. For example, the inner seal surface 312 faces and/or defines the slot 320. The seal body 310 include an outer seal surface 314 configured to be sealingly coupled to the housing 110 (shown in FIG. 1). The outer seal surface 314 surrounds the outer perimeter of the seal body 310. The outer seal surface 314 may include one or more sealing ribs 316 configured to interface with the housing 110. The seal body 310 may be elongated to provide larger sealing surfaces 312, 314.

In an exemplary embodiment, the slot 320 includes a slot base 324 between a first slot arm 326 and a second slot arm 328. The slot base 324 may be curved, such as having a curvature similar to the curvature of the crimp base 234 and/or the transition base 254. The slot base 324 may be curved at the transitions to the first and second slot arms 326, 328. In an exemplary embodiment, the first and second slot arms 326, 328 extend upward from the slot base 324 at angles away from each other. The first and second slot arms 326, 328 may be flat or planar extending at the angles away from each other. In alternative embodiments, the first and second slot arms 326, 328 may be curved.

In an exemplary embodiment, the first and second slot arms 326, 328 may have shapes (for example, curved or flat) and extend at angles that match the shapes and angles of the first and second crimp arms 236, 238 and/or the first and second transition arms 256 and 258. For example, in an exemplary embodiment, the slot 320 has a slot profile that is complementary to the crimp barrel profile and/or the transition portion profile. For example, the slot profile may be generally U-shaped defined by the slot base 324 and the first and second slot arms 326, 328. The slot profile matches the crimp barrel profile and/or the transition portion profile to allow the terminal seal 300 to be loaded over the crimp barrel 232 onto the seal seat 264 of the transition portion 250. Having the matching profiles allows the terminal seal 300 to be loaded onto the crimp barrel 232 and slid forward onto the terminal body 210 into the sealing position on the seal seat 264. The terminal seal 300 is configured to be sealingly coupled to the terminal body 210 at the seal seat 264 forward of the crimp barrel 232. In an exemplary embodiment, the terminal seal 300 is pre-formed and loaded over the crimp barrel 232 into position on the terminal body 210 rather than being overmolded or formed in place on the terminal body 210, which provides a lower manufacturing cost.

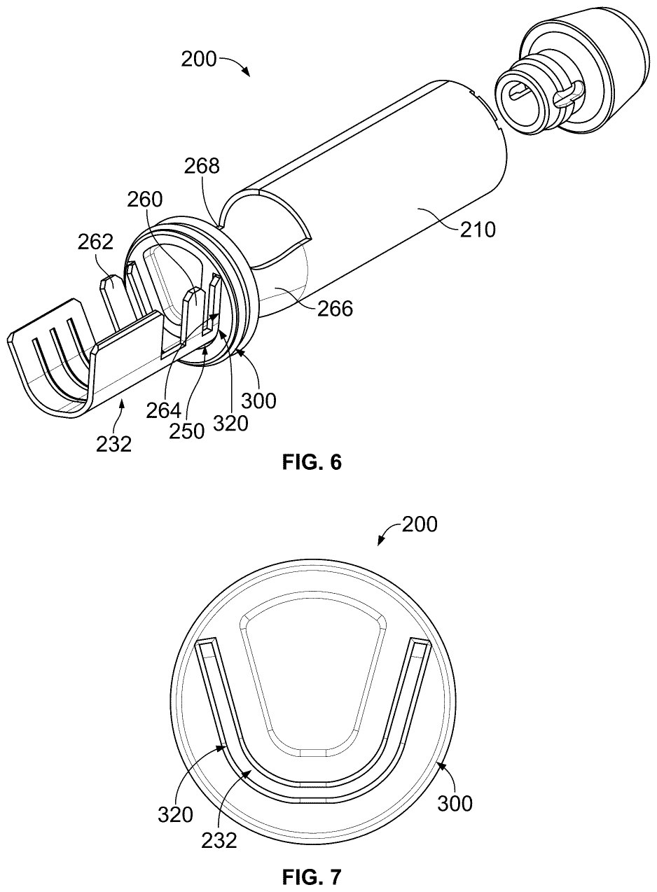

FIG. 6 is a rear perspective view of the power terminal assembly 200 in accordance with an exemplary embodiment showing the terminal seal 300 coupled to the transition portion 250 of the terminal body 210. FIG. 7 is an end view of the power terminal assembly 200 in accordance with an exemplary embodiment showing the terminal seal 300 coupled to the terminal body 210. FIGS. 6 and 7 show the power terminal assembly 200 at an intermediate stage of assembly, such as prior to forming the retention wings 260, 262.

During assembly, the terminal seal 300 is rear loaded onto the end of the terminal body 210. The terminal seal 300 is coupled to the terminal body 210 prior to crimping the crimp barrel 232 to the end of the power cable 204. During assembly, the slot 320 is aligned with the crimp barrel 232 and the terminal seal 300 is pressed onto the end of the terminal body 210. The terminal seal 300 is pressed forward and slid along the crimp barrel 232. The terminal seal 300 is slid forward of the crimp barrel 232 and forward of the retention wings 260, 262 onto the seal seat 264 of the transition portion 250. The flared portions 266, 268 stop forward sliding of the terminal seal 300. The flared portions 266, 268 locate the terminal seal 300 on the seal seat 264. When the terminal seal 300 is positioned at the seal seat 264, the retention wings 260, 262 are located rearward of the terminal seal 300.

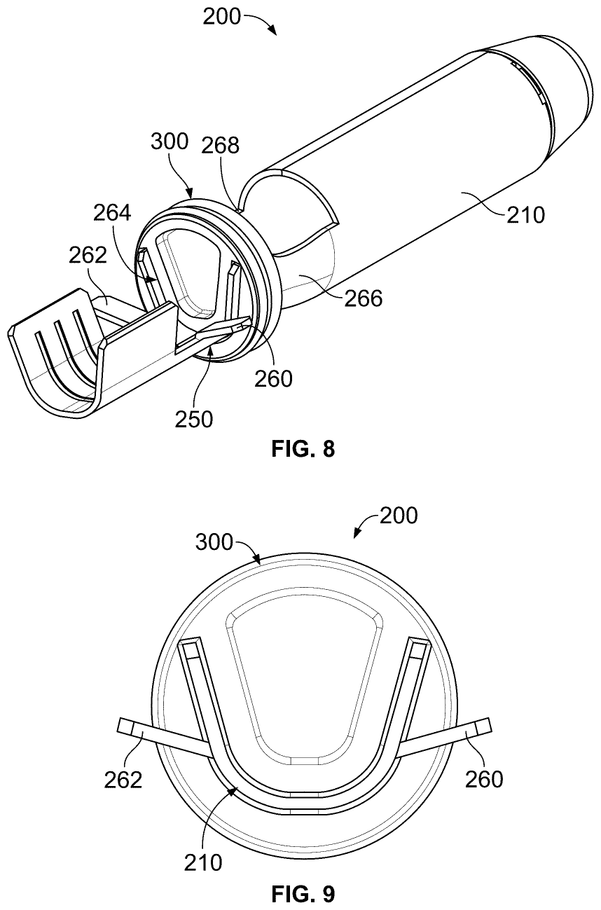

FIG. 8 is a rear perspective view of the power terminal assembly 200 in accordance with an exemplary embodiment showing the terminal seal 300 coupled to the transition portion 250 of the terminal body 210. FIG. 9 is an end view of the power terminal assembly 200 in accordance with an exemplary embodiment showing the terminal seal 300 coupled to the terminal body 210. FIGS. 6 and 7 show the retention wings 260, 262 in a formed state in blocking positions rearward of the terminal seal 300.

During assembly, after the terminal seal 300 is positioned at the seal seat 264, the retention wings 260, 262 are bent outward to the blocking positions. The terminal seal 300 is retained at the seal seat 264 between the retention wings 260, 262 and the flared portions 266, 268. The terminal seal 300 is sealed to the terminal body 210 at the seal seat 264.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A power terminal comprising:
a terminal body extending between a mating end and a terminating end, the mating end configured to be mated with a mating power terminal, the terminating end including a crimp barrel configured to be crimped to a power cable; and
a terminal seal coupled to the terminal body between the mating end and the terminating end, the terminal seal including a seal body having a slot, the slot receiving the crimp barrel as the terminal seal is loaded over the crimp barrel onto the terminal body, the terminal seal sealingly coupled to the terminal body forward of the crimp barrel.

2. The power terminal of claim 1, wherein the terminal seal is rear loaded onto the terminal body sliding along the crimp barrel to a sealing position.

3. The power terminal of claim 1, wherein the terminal seal is pre-formed and loaded over the crimp barrel into position on the terminal body.

4. The power terminal of claim 1, wherein the slot has a slot profile complementary with a crimp barrel profile of the crimp barrel.

5. The power terminal of claim 1, wherein the crimp barrel is generally U-shaped prior to crimping to the power cable, the slot having a matching U-shaped profile.

6. The power terminal of claim 1, wherein the crimp barrel includes a crimp base between a first crimp arm and a second crimp arm, the crimp base being curved, the first and second crimp arms extending from the crimp base at angles away from each other prior to crimping, the slot including a slot base between a first slot arm and a second slot arm, the slot base being curved, the first and second slot arms extending at angles away from each other.

7. The power terminal of claim 1, wherein the terminal body includes a transition portion between the mating end and the terminating end, the terminal seal being sealingly coupled to the transition portion.

8. The power terminal of claim 7, wherein the crimp barrel has a crimp barrel profile, the transition portion has a transition portion profile, and the slot has a slot profile, wherein the crimp barrel profile, the transition portion profile, and the slot profile matching each other.

9. The power terminal of claim 7, wherein the transition portion includes retention wings configured to be bent outward to retain the terminal seal on the transition portion.

10. The power terminal of claim 1, wherein the terminal body is a stamped and formed body rolled into a cylinder at the mating end having edges forming a seam along the cylinder.

11. The power terminal of claim 1, wherein the mating end includes a pin.

12. The power terminal of claim 1, wherein the mating end includes a socket.

13. A power terminal comprising:
a terminal body extending between a mating end and a terminating end, the mating end configured to be mated with a mating power terminal, the terminating end including a crimp barrel configured to be crimped to a power cable, the crimp barrel having a formed shape prior to crimping to the power cable and a crimped shape, different from the formed shape, after crimping to the power cable; and
a terminal seal coupled to the terminal body between the mating end and the terminating end, the terminal seal including a seal body having a slot, the slot having a shape corresponding to the formed shape of the crimp barrel such that the slot is configured to receive the crimp barrel as the terminal seal is loaded over the crimp barrel onto the terminal body, the terminal seal sealingly coupled to the terminal body forward of the crimp barrel.

14. The power terminal of claim 13, wherein the terminal seal is rear loaded onto the terminal body sliding along the crimp barrel to a sealing position.

15. The power terminal of claim 13, wherein the crimp barrel is generally U-shaped prior to crimping to the power cable, the slot having a matching U-shaped profile.

16. The power terminal of claim 13, wherein the crimp barrel includes a crimp base between a first crimp arm and a second crimp arm, the crimp base being curved, the first and second crimp arms extending from the crimp base at angles away from each other prior to crimping, the slot including a slot base between a first slot arm and a second slot arm, the slot base being curved, the first and second slot arms extending at angles away from each other.

17. The power terminal of claim 13, wherein the terminal body includes a transition portion between the mating end and the terminating end, the terminal seal being sealingly coupled to the transition portion, wherein the crimp barrel has a crimp barrel profile, the transition portion has a transition portion profile, and the slot has a slot profile, the crimp barrel profile, the transition portion profile, and the slot profile matching each other.

18. The power terminal of claim 13, wherein the terminal body includes retention wings configured to be bent outward to retain the terminal seal on the terminal body.

19. A charging inlet assembly comprising:
a charging inlet housing configured to be mounted to a vehicle, the charging inlet housing including a charging receptacle configured to receive a charging plug, the charging inlet housing including terminal channels open to the charging receptacle; and
power terminals received in the terminal channels, each power terminal including a terminal body and a terminal seal coupled to the terminal body;
the terminal body extending between a mating end and a terminating end, the mating end located in the charging receptacle and configured to be mated with a mating power terminal of the charging plug, the terminating end including a crimp barrel configured to be crimped to a power cable; and
the terminal seal including a seal body having a slot, the slot receiving the crimp barrel as the terminal seal is loaded over the crimp barrel onto the terminal body, the terminal seal sealingly coupled to the terminal body forward of the crimp barrel.

20. The charging inlet assembly of claim 19, wherein the terminal body includes a transition portion between the mating end and the terminating end, the terminal seal being sealingly coupled to the transition portion, wherein the crimp barrel has a crimp barrel profile, the transition portion has a transition portion profile, and the slot has a slot profile, the crimp barrel profile, the transition portion profile, and the slot profile matching each other.
